(19) United States
(12) Patent Application Publication
(10) Pub. No.: US 2024/0406765 A1
(43) Pub. Date: Dec. 5, 2024

(54) DISTRIBUTED UNIT ARCHITECTURE FOR INCREASING VRAN RESILIENCE

(71) Applicant: Microsoft Technology Licensing, LLC, Redmond, WA (US)

(72) Inventors: Anuj KALIA, San Francisco, CA (US); Junzhi GONG, Cambridge, MA (US)

(21) Appl. No.: 18/325,802

(22) Filed: May 30, 2023

(51) Int. Cl. H04W 24/04; H04W 76/10

(52) U.S. Cl. CPC H04W 24/04; H04W 76/10

(57) ABSTRACT

The present disclosure relates to systems, methods, and computer-readable media for increasing resiliency in distributed units of a virtual radio access network (vRAN) of a telecommunications network (e.g., a 5G telecommunications network). Systems described herein involve establishing, using a middlebox entity, stream control transmission protocol (SCTP) connections between each of multiple distributed units and a centralized unit. The middlebox entity may monitor failure conditions to detect a failure condition of a primary distributed unit and, based on the detected failure condition, quickly re-establish a connection between a backup distributed unit having the SCTP connection previously established with the centralized unit. The features described herein provide additional resiliency by enabling a centralized unit to be timely notified of a distributed unit failure as well as establish communication between the centralized unit and a backup distributed unit without interrupting services or sessions on the telecommunications network.

### BACKGROUND

Communication networks (e.g., cellular networks) can provide computing devices with access to services available from one or more data networks. A cellular network is typically distributed over geographical areas that often include base stations, radio access networks, core networks, and/or edge networks that collectively provide a variety of services and coverage to end-user devices (e.g., mobile devices). These devices and components of the cellular network provide reliable access to a data network and other communication services by mobile devices over a wide geographic area. In many instances these cellular networks provide mobile devices access to the cloud.

As noted above, cellular networks include a number of network components. For example, cellular networks often include radio access network (RAN) components, which may be implemented through a combination of physical and virtualized components. More recently, and particularly with the advent of more modern telecommunications networks (e.g., 4G, 5G, and future generations of telecommunications networks that employ 3GPP standards), many RAN components are virtualized as services and other functions that are deployed on network resources of a cloud computing system. These virtual RANs (vRANs) allow running RAN processing and other tasks on commodity servers, and are gaining adoption in modern cellular networks.

As cellular networks have grown in popularity and in complexity, demand for faster communication speeds and lower latency has increased. This increase in demand can cause problems when unexpected failures, such as dropped calls or unexpected handoffs between components of the cellular network happen. Indeed, one property of modern vRANs often include distributed units that facilitate processing, converting, and communicating wireless signals between components of the cellular network. While these distributed units provide many important features of telecommunications networks, unplanned failures or deficiencies in the vRAN as well as the distributed units inability to handle these failures or deficiencies can contribute to a lack of resiliency in the cellular network. Indeed, as a result of existing protocols and common architectures that exist in cellular networks, current implementations of distributed units and other RAN components within cellular networks are often unable to recover from various failures that occur within components of the RAN.

These and other problems exist in connection with increasing resiliency in cellular networks, and particularly within virtual RANs (vRANs).

### BRIEF DESCRIPTION OF THE DRAWINGS

FIG. 1 illustrates an example environment including a middlebox resilience system implemented between distributed units and a centralized unit in accordance with one or more embodiments.

FIG. 2 illustrates an example implementation of the middlebox resilience system shown in FIG. 1 in accordance with one or more embodiments.

FIG. 3 illustrates an example environment including a middlebox resilience system implemented on a centralized unit in accordance with one or more embodiments.

FIG. 4 illustrates an example implementation of the middlebox resilience system shown in FIG. 3 in accordance with one or more embodiments.

FIG. 5 illustrates an example series of acts for increasing resilience of a vRAN using a middlebox resilience system in accordance with one or more embodiments.

FIG. 6 illustrates certain components that may be included within a computer system.

### DETAILED DESCRIPTION

The present disclosure relates generally to systems, methods, and computer readable media for increasing resilience in distributed units implemented on a vRAN of a telecommunications network. In particular, as will be discussed in further detail herein, the present disclosure involves implementing a middlebox resiliency system (e.g., a middlebox entity) that provides fast and efficient awareness of any failure conditions of distributed units in the vRAN environment. As will be discussed below, this awareness enables the middlebox resiliency system to facilitate a quick recovery of the failure condition(s) in such a way as to decrease the number of service interruptions that would otherwise occur in an environment in which a centralized unit does not have instant awareness of distributed unit failures.

As an illustrative example, systems described herein may include implementation of a middlebox entity in a telecommunications environment having distributed units and centralized units implemented in connection with a vRAN. The middlebox entity may establish a first connection (e.g., a first stream control transmission protocol (SCTP)) connection between the centralized unit and a first distributed unit (e.g., a primary distributed unit). The middlebox entity may also establish a second connection (e.g., a second SCTP connection) between the centralized unit and a second distributed unit (e.g., a backup distributed unit). The middlebox entity may facilitate detection of a failure condition of the first distributed unit and, in response to detecting the failure condition, activate the second connection and cause fronthaul traffic of a datacenter (e.g., an edge datacenter) to be routed to the second distributed unit.

As will be discussed in further detail below, the present disclosure includes a number of practical applications having features described herein that provide benefits and/or solve problems associated with increasing resiliency in vRANs of a telecommunications network. Some example benefits are discussed herein in connection with features and functionality provided by a middlebox entity (referred to in some embodiments as a middlebox resiliency system). It will be appreciated that benefits discussed herein in connection with one or more embodiments are provided by way of example and are not intended to be an exhaustive list of all possible benefits of the middlebox entity and resilient vRAN(s).

For example, by establishing connections between both a first distributed unit and the centralized unit, the middlebox resiliency system facilitates connections that can be activated within a very short amount of time in response to detecting a failure condition. Indeed, a connection between the centralized unit and the backup distributed unit can be activated as soon as the middlebox resiliency system becomes aware that the first (primary) distributed unit is down or has otherwise experienced a failure condition. This reduction in downtime reduces service interruptions for end-user devices and otherwise increases vRAN resiliency.

In addition to facilitating fast recovery from distributed unit failures, the middlebox resiliency system provides real-time awareness of failure conditions associated with the distributed units, thus enabling the middlebox resiliency system and the centralized unit to quickly initiate recovery procedures when a failure condition is detected. Indeed, in contrast to conventional approaches in which the centralized unit is unaware of a distributed unit failure until a standard-define timeout (e.g., 30 seconds) the middlebox resiliency system provides significantly faster awareness (e.g., 1 millisecond), which allows the vRAN environment to recover within a much quicker period of time and without causing significant service interruptions.

In addition to providing faster recovery and enhanced vRAN resiliency generally, the middlebox resiliency system provides the above-benefits without causing the backup distributed unit to consume unnecessary power or processing resources. Indeed, in one or more embodiments, the distributed unit and stream control transmission protocol (SCTP) connection are setup in a low-power mode that allows the distributed unit to be operational within a short period of time, but without expending unnecessary power and computing resources while the backup distributed unit is inactive.

The middlebox resiliency system additionally provides a flexible approach to increasing vRAN resiliency that can be implemented in both current and future communication environments. For example, the middlebox resiliency system may be implemented on a server device that is placed between the distributed units and a centralized unit and configured to provide the herein-discussed features and functionalities without fundamentally changing the underlying operations of the distributed units and/or centralized units. In some examples, the middlebox resiliency system is implemented as a software module on a server device of the centralized unit (or within the centralized unit), thus providing enhanced functionality of the centralized unit being combinable with other services and features provided by the centralized unit.

Moreover, each of the above-benefits provide additional resilience in a vRAN environment in a manner that reduces interruptions in communications between UEs and other devices. Embodiments described herein provide this enhanced vRAN resilience without implementing any complex modifications to existing protocols and can be implemented within the framework of telecommunication standards. In addition, some implementations of the middlebox resiliency system are agnostic to particular hardware implementations being adaptable to different hardware models and brands. The middlebox resiliency system may also be implemented in a 5G mobile network or other telecommunications networks that make use of distributed units, edge networks, or other components that are becoming increasingly popular in modern communication systems.

As illustrated in the foregoing discussion and as will be discussed in further detail herein, the present disclosure utilizes a variety of terms to described features and advantages of methods and systems described herein. Some of these terms will be discussed in further detail below.

As used herein, a “cloud computing system” refers to a network of connected computing devices that provide various services to computing devices (e.g., customer devices). For instance, as mentioned above, a distributed computing system can include a collection of physical server devices (e.g., server nodes) organized in a hierarchical structure including clusters, computing zones, virtual local area networks (VLANs), racks, fault domains, etc. In one or more embodiments described herein a portion of the cellular network (e.g., a core network) may be implemented in whole or in part on a cloud computing system. A data network may be implemented on the same or on a different cloud computing network as the portion of the cellular network. In one or more embodiments described herein, portions of a RAN (e.g., the vRAN) may be implemented in whole or in part on the cloud computing system.

In one or more embodiments, the cloud computing system includes one or more edge networks. As used herein, an “edge network” or “edge data center” may refer interchangeably to an extension of the cloud computing system located on a periphery of the cloud computing system. The edge network may refer to a hierarchy of one or more devices that provide connectivity to devices and/or services on a datacenter within a cloud computing system framework. An edge network may provide a number of cloud computing services on hardware having associated configurations in force without requiring that a client communicate with internal components of the cloud computing infrastructure. Indeed, edge networks provide virtual access points that enables more direct communication with components of the cloud computing system than another entry point, such as a public entry point, to the cloud computing system.

As used herein, a “telecommunications network” may refer to a system of interconnected devices that are distributed over geographical areas and which provide communication and data capabilities to end-user devices (e.g., mobile and non-mobile devices). In one or more embodiments described herein, a telecommunications network refers to a cellular network that includes radio access network (RAN) components, core network components, and network functions implemented on server nodes on the cellular network. In one or more embodiments described herein, the telecommunications network refers specifically to a fifth generation (5G) network environment; however, other implementations may include previous generations (e.g., 2G, 3G, 4G) or future generations (6G and beyond) that make use of network functions implemented on computing devices of the telecommunications network.

In one or more embodiments described herein, an edge network or datacenter may include a number of distributed units deployed as part of a vRAN. The distributed unit may refer to a component that is responsible for handling lower layers of processing functions in the architecture of the vRAN. For example, a distributed unit may be configured to handle a plurality of layers (e.g., physical layer, multi-access edge computing (MEC), the radio link control (RLC) and any other tasks associated with converting wireless signals into packet formats that a centralized unit is configured to process. Indeed, in one or more embodiments described herein, a distributed unit includes lower layers of a vRAN stack including, by way of example, the Physical (PHY), media access control (MAC), and radio access control (RLC) layers.

As used herein, the centralized unit provides centralized functions (e.g., baseband processing, control functions, resource coordination functions) of the vRAN and acts as a central point of management for multiple distributed units and, in some implementations, across multiple edge networks. Indeed, in one or more embodiments, the centralized unit provides virtual RAN services at a central location providing additional flexibility and scalability for the vRAN. In one or more embodiments, a centralized unit services hundreds or thousands of distributed units across one or multiple edge datacenters.

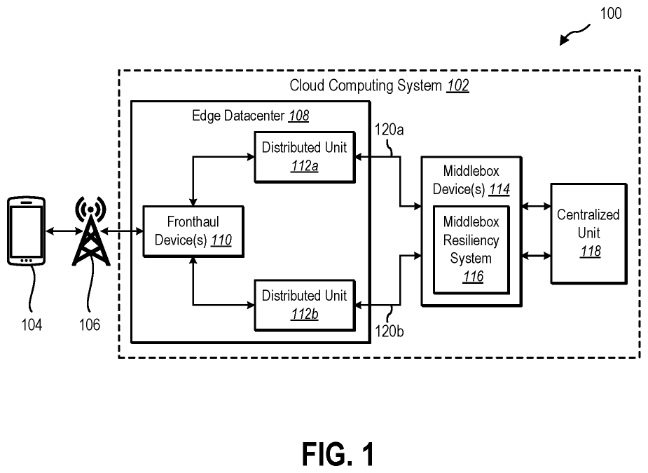

Additional detail will now be provided regarding systems described herein in relation to a middlebox resiliency system that increases resilience of a vRAN within a telecommunications network environment. For example, FIG. 1 illustrates an example environment 100 for implementing features and functionality of a middlebox resiliency system in accordance with one or more embodiments described herein. As shown in FIG. 1, the environment 100 illustrates example portions of a cellular network, which may be implemented in whole or in part on a cloud computing system 102.

For example, the environment includes a user equipment 104 (or simply “UE 104”), a radio unit 106, and edge datacenter 108 having fronthaul device(s) 110 and distributed units 112a-b implemented thereon. The environment additionally includes a middlebox device(s) 114 having the middlebox resiliency system 116 implemented thereon and a centralized unit 118 in communication with the middlebox resiliency system 116 and distributed units 112a-b. The components 106-118 of the cellular network may collectively form a public or private cellular network and, more specifically, make up components of a RAN (inclusive of the vRAN).

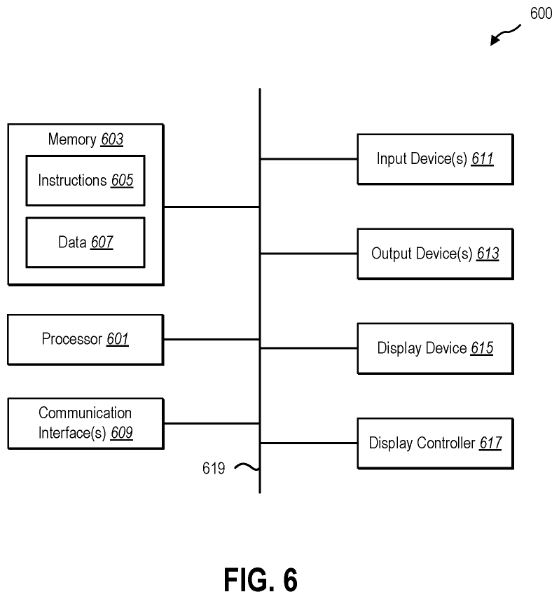

The UE 104 (e.g., client device) may refer to a variety of computing devices or end-user devices. For example, the UE 104 may refer to a mobile or non-mobile user device, such as a laptop, desktop, phone, tablet, information of things (IoT) device, or other device capable of communicating with devices on the cloud computing system 102 via one or more access points, such as the radio unit 106 and/or components of the vRAN. Alternatively, the UE 104 may refer to a server device or other non-mobile computing device that is not on the cloud computing system 102, but which serves as an end-user device. Additional detail in connection with general features and functionalities of a computing device, such as the UE 104, is discussed below in connection with FIG. 6.

The radio unit 106 may refer to one or more components of a device or system of devices that are tasked with providing an access point to other devices of a cellular network (e.g., devices of the cloud computing system 102). More specifically, the radio unit 106 may refer to a base station or cell station associated with a particular area of coverage or any physical access point of a RAN through which the UE 104 communicates with devices on the cellular network or core network. In one or more embodiments, the radio unit 106 refers to a base station through which a UE 104 communicates through one or more distributed units, centralized unit, or other components of a vRAN described herein.

As noted above, the edge datacenter 108 may refer to a portion of the cloud computing system 102 near or proximate to end-users while providing connectivity to internal or remote portions of the cloud computing system 102. The edge datacenter 108 may include any number of servers having network functions, virtual machines, or other components thereon that provide connectivity and communication capabilities between the UE 104 and services or devices at a lower latency than conventional systems in which a UE communicates directly with components or devices on a more remote datacenter.

As noted above, the edge datacenter 108 may be referred to interchangeably as an edge network. While one or more embodiments described herein refer specifically to implementations of a vRAN in which components such as distributed units, front haul devices, centralized units, etc. are implemented on the edge datacenter 108, the features described herein may be implemented on a centralized datacenter or otherwise less centralized or distributed implementation of a cloud computing system 102.

As shown in FIG. 1, the edge datacenter 108 includes one or more front haul device(s) 110 and a number of distributed units 112a-b hosted thereon. The front haul device(s) 110 may refer to one or more devices tasked with handling routing, switching, and other communication directing tasks associated with providing communications received from a UE 104 (via the radio unit 106) to one or more distributed units 112. IN one or more embodiments, the front haul device(s) 110 refers to a network function (e.g., a front haul network function) that facilitates delivery of communications via general purpose computing devices (e.g., an edge server node). Other implementations of the front haul device(s) 110 may be implemented on specialized hardware specifically configured or otherwise tasked with performing front haul related tasks in the vRAN. In one or more embodiments, the front haul device(s) 110 includes an Ethernet switch positioned between the radio unit 106 and the distributed units 112a-b.

As just mentioned, the edge datacenter 108 includes a number of distributed units 112a-b, which (also discussed above) may refer to devices or functions that are configured to handle a plurality of lower layers of protocol in providing or otherwise managing communications between devices of a cellular network. While FIG. 1 illustrates and example showing a first distributed unit 112a and a second distributed unit 112b, other examples include additional distributed units on a given edge datacenter. In addition, while not shown in FIG. 1, the edge datacenter 108 may include multiple pairs of primary and backup distributed units similar to first and second distributed units 112a-n discussed herein. In one or more embodiments, the first distributed unit 112a is referred to as a primary or active distributed unit while the second distributed unit 112b is referred to as a secondary or backup distributed unit.

Also shown in FIG. 1, and as noted above, the environment 100 includes a centralized unit 118. The centralized unit 118 may refer to a unit on the cloud computing system 102 (e.g., on a central datacenter) that manages operation of any number of distributed units and other vRAN components. The centralized unit 118 may provide baseband processing, control functions, resource coordination functions, or simply provide a central point of management for any number of distributed units on the edge datacenter 108 and, in some cases, across multiple edge datacenters having distributed units deployed thereon.

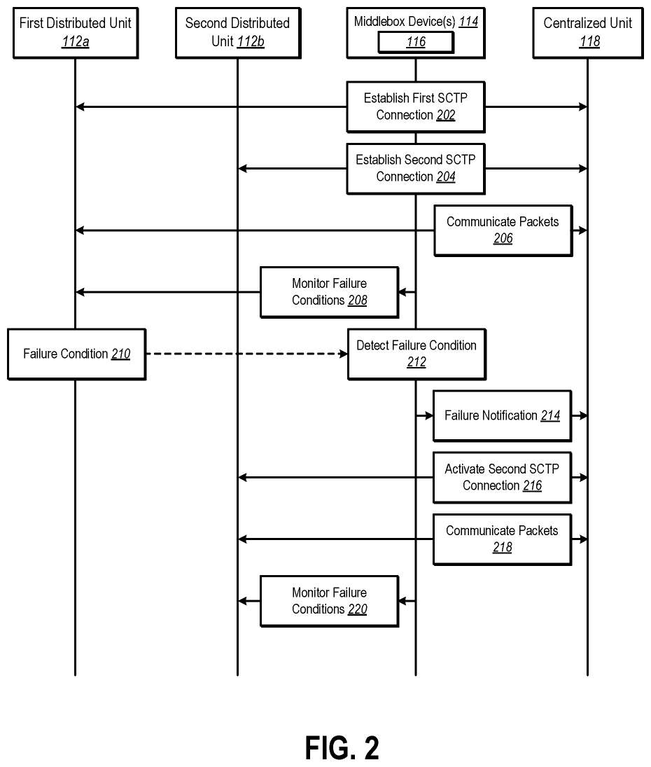

Additional detail will now be given in connection with the middlebox resiliency system 116 on a middlebox device(s) 114 in connection with other components of the vRAN, as shown in FIG. 1. Further details will also be discussed below in connection with an example implementation shown in FIG. 2. It will be appreciated that the middlebox device(s) 114 may refer to one or multiple server devices (e.g., server node(s)) on the cloud computing system 102 on which features of the middlebox resiliency system 116 are implemented.

In one or more embodiments, the middlebox resiliency system 116 refers to a software application, software package, or other service hosted or provided by a server device (e.g., the middlebox device(s) 114) on the cloud computing system 102. As noted above, the middlebox resiliency system 116 provides features and functionality associated with increasing resiliency of the distributed units 112a-b on the edge datacenter 108 by decreasing potential downtimes caused as a result of failure conditions that occur on the distributed units 112a-b (e.g., on the primary distributed unit 112a).

As will be discussed in further detail below, the middlebox resiliency system 116 can increase resiliency of the vRAN by establishing connections between the distributed units 112a-b (i.e., both of the distributed units 112a-b) and the centralized unit 118. For example, as shown in FIG. 1, the middlebox resiliency system 116 establishes a first connection 120a between the first distributed unit 112a and the centralized unit 118. This first connection 120a may refer to a primary connection that enables the primary distributed unit (e.g., the first distributed unit 112a) to communicate with or otherwise interact with (and be managed by) the centralized unit 118. In addition to the first connection 120a, the middlebox resiliency system 116 may establish a second connection 120b between the second distributed unit 112b and the centralized unit 118. The second connection 120b may refer to a secondary or backup connection that enables the backup unit (e.g., the second distributed unit 112b) to communicate with or otherwise interact with (and be managed by) the centralized unit 118.

In one or more embodiments, the connections 120a-b refer to SCTP connections that are established between the respective distributed units 112a-b and the centralized unit 118. For example, the middlebox resiliency system 116 may establish a first SCTP connection between the first distributed unit 112a and the centralized unit 118 and establish a second SCTP connection between the second distributed unit 112b and the centralized unit 118. The SCTP connections may be established prior to any communications happening between the distributed units 112a-b and the centralized unit 118. In some embodiments, the second SCTP connection may be established after establishing the first SCTP connection and while the first distributed unit 112a is already regularly communicating with the centralized unit 118.

By establishing the SCTP connections between the distributed units 112a-b and the centralized unit, the middlebox resiliency system 116 enables both the distributed units to quickly establish communication with the centralized unit 118 in the event of unexpected failures. More specifically, while a primary distributed unit (e.g., the first distributed unit 112a) is in frequent communication with the centralized unit 118 under normal operating conditions, the backup distributed unit (e.g., the second distributed unit 112b) may operate in a standby or low power mode for an indefinite period of time until a failure condition is observed or otherwise detected for the first distributed unit 112a. By establishing the second SCTP connection, the second distributed unit may simply power up or transition from the standby or low power mode to an operational or active mode, thus enabling the second distributed unit 112b to quickly and efficiently resume communication session(s) involving the UE 104 (and other end-user devices) and the centralized unit 118.

In addition to establishing the first and second connections 120a-b, the middlebox resiliency system 116 may track conditions and detect whether a failure condition has occurred. For example, the middlebox resiliency system 116 may detect whether the first distributed unit 112a has failed, or whether a specific server device on which the first distributed unit 112a is running has failed. As used herein, a failure condition of a distributed unit may refer to a variety of scenarios in which a distributed unit is not operating as configured or otherwise expected. For example, a failure condition may include a hardware failure of a server node, network connectivity issues, software or configuration problems, or overloading of a particular distributed unit. It will be noted that the distributed units 112a-b are likely implemented on different server devices in order for a device failure to not effect both the first and second distributed units 112a-b.

As will be discussed below, the middlebox resiliency system 116 can detect failure conditions in a number of ways. For example, in one or more embodiments, the middlebox resiliency system 116 pings the first distributed unit 112a at periodic intervals to monitor responsiveness of the first distributed unit 112a at specific times. In one or more embodiments, the distributed units 112a-b may have agents installed thereon that are configured to cause the distributed units 112a-b to communicate status messages or other signals to the middlebox resiliency system 116 (or to the centralized unit 118 directly) that the middlebox resiliency system 116 uses in determining responsiveness of the distributed unit(s) 112a-b over time. In one or more embodiments, the fronthaul device(s) 110 provides communications to the middlebox resiliency system 116 indicating responsiveness of the distributed units 112a-b or other health-related signals of one or both of the distributed units 112a-b. For example, the fronthaul device(s) 110 may communicate an indication of a health status or other notification based on a threshold period of time passing without detecting any communications between the fronthaul device(s) 110 (e.g., an Ethernet switch) and the distributed unit(s). The middlebox resiliency system 116 may determine whether a failure condition exists based on timing or characteristics of one or more of these types of communications.

As noted above, in one or more embodiments, the middlebox resiliency system 116 refers to a software application or software package that is implemented on one or across multiple server devices. For example, the middlebox resiliency system 116 may be implemented as a service or network function installed on a server node of the cloud computing system 102. In one or more embodiments, each of different discrete features of the middlebox resiliency system 116 can be implemented as separate or distinct software applications or packages on a single or across multiple server devices. As an example, in one or more embodiments, the middlebox resiliency system 116 is implemented on a single server device. As another example, a first portion of the middlebox resiliency system 116 (e.g., a portion dedicated to detecting failure conditions) is implemented on a first server device while a second portion of the middlebox resiliency system 116 (e.g., a portion dedicated to establishing the SCTP connections) is implemented on a second server device. Other implementations may include additional or fewer devices.

Additional detail will now be discussed in connection with an example implementation in which the distributed units 112a-b, the centralized unit 118, and the middlebox resiliency system 116 communicate with one another in a manner that increases resilience of the vRAN. In particular, FIG. 2 illustrates an example implementation in which multiple distributed units 112a-b, a centralized unit 118, and the middlebox resiliency system 116 cooperatively increase the resilience of the vRAN on which the respective components are implemented. The distributed units 112a, centralized unit 118, and middlebox resiliency system 116 may include similar features as shown in the examples illustrated and discussed in connection with FIG. 1.

As shown in FIG. 2, the middlebox resiliency system 116 performs an act 202 of establishing a first SCTP connection between the first distributed unit 112a and the centralized unit 118. As further shown, the middlebox resiliency system 116 performs an act 204 of establishing a second SCTP connection between the second distributed unit 112b and the centralized unit 118. Establishing the SCTP connections may be done in sequence as shown in FIG. 2. Other implementations may involve establishing the SCTP connection asynchronously. For example, after the first SCTP connection has been established and while the first distributed unit 112a is in communication with the centralized unit 118, the middlebox resiliency system 116 may establish the second SCTP connection. The middlebox resiliency system 116 may additionally set up additional SCTP connections between other distributed units and the centralized unit 118.

As noted above, the first distributed unit 112a may refer to a primary distributed unit while the second distributed unit 112b refers to a backup or secondary unit. In this example, and as shown in FIG. 2, the centralized unit 118 and the first distributed unit 112a may perform an act 206 of communicating packets between the respective units. As discussed above, the first distributed unit 112a may receive and process communications from the UE 104 and provide the processed packets to the centralized unit 118 and/or to other entities within a cellular network. In one or more embodiments, the communication packets are communicated via the first SCTP connection.

As further shown in FIG. 2, the middlebox resiliency system 116 performs an act 208 of monitoring failure conditions of the first distributed unit 112a. As discussed above, the middlebox resiliency system 116 may monitor conditions of the first distributed unit 112a in a number of ways. For example, the middlebox resiliency system 116 may implement or cause an agent to be installed on the first distributed unit 112a that is tasked with providing regular and/or frequent communications to the middlebox resiliency system 116 indicating a health status of the first distributed unit 112a. Alternatively, this may be performed by the middlebox resiliency system 116 pinging the first distributed unit 112a or checking communication conditions at regular intervals (e.g., once per millisecond).

In one or more embodiments, the middlebox resiliency system 116 may monitor the failure conditions by receiving signals from the front haul device(s) 110 indicating a state of network or device conditions of the first distributed unit 112a. In this example, the front haul device(s) 110 may be configured to provide a communication of a possible failure condition based on a period of time without receiving any communications form the first distributed unit 112a. In this example, the front haul device(s) 110 may provide a single communication indicating that the period of time without receiving communications has passed rather than providing regular or frequent communications about the failure condition(s) of the first distributed unit 112a.

The first distributed unit 112a may operate under normal operating conditions for an indefinite period of time. FIG. 2 shows an example in which the first distributed unit 112a performs an act 210 of experiencing a failure condition. As noted above, the failure condition may refer to a variety of conditions associated with failure of the distributed unit 112a to operate as designed or otherwise configured. This failure condition may be caused by a hardware condition, a network condition, software malfunction, or any combination of different issues that may occur within a distributed unit.

As shown in FIG. 2, the middlebox resiliency system 116 may perform an act 212 of detecting the failure condition. In one or more embodiments, the middlebox resiliency system 116 does not have any awareness of the specific type of failure condition, only that certain failure conditions are met (e.g., delay of packets, inability of the distributed unit to communicate with other components on the vRAN, or other scenario that the middlebox resiliency system 116 is capable of detecting). In one or more embodiments, the middlebox resiliency system 116 detects the failure condition based on information received from the distributed unit 112a. In one or more embodiments, the middlebox resiliency system 116 determines that the failure condition exists based on an absence of information received from the distributed unit 112a. In one or more embodiments, the middlebox resiliency system 116 determines or detects the failure condition based on information or signals received by other entities of the vRAN (e.g., the front haul device(s) 110).

Upon detecting the failure condition, the middlebox resiliency system 116 performs an act 214 of providing a failure notification to the centralized unit 118. For example, the middlebox resiliency system 116 may provide an indication of a period of time that has passed without receiving any communications from the first distributed unit 112a. In one or more embodiments, the notification includes instructions or a signal of the second distributed unit 112b and/or the second SCTP connection that was previously established to enable recovery from the failure condition and that the second distributed unit 112b is ready to continue the communication session previously associated with the first distributed unit 112a.

In one or more embodiments, providing the notification includes the middlebox resiliency system 116 sending an SCTP-shutdown signal to the centralized unit 118 to clear a state of the first distributed unit 112a from the centralized unit 118. By shutting down or otherwise terminating the primary distributed unit in this manner, the middlebox resiliency system 116 avoids a scenario in which a UE attempts to attach via the second distributed unit 112b as a result of a stale UE state maintained on the centralized unit 118. Conventionally, where the centralized unit 118 is unaware of the primary distributed unit's failure, the centralized unit 118 might send a request (e.g., a F1AP request) to the primary distributed unit to release a connection of the UE. Because of the failure condition, however, the primary unit would likely be unable to response to this request and the centralized unit 118 would await a response and, ultimately, experience a service interruption for waiting longer than the telecommunications network would allow. By sending the SCTP-shutdown signal from the middlebox resiliency system 116, the centralized unit 118 may gain awareness of the failure condition and avoid performing an action that may cause further service interruption.

While not shown in FIG. 2, in one or more embodiments, the middlebox resiliency system 116 additionally provides a notification and/or reconfigures the fronthaul device(s) 110 to re-route fronthaul traffic to the second distributed unit 112b. This can be done concurrently to activating the second SCTP connection and causing the second distributed unit to engage an active or operational state.

As shown in FIG. 2, in response to communication of the failure notification, the second distributed unit 112b and the centralized unit 118 may perform an act 216 of activating the second SCTP connection. In one or more embodiments, the second distributed unit 112b engages an operational mode from a standby or low power mode and resumes the role of the first distributed unit 112a. In this example, the second distributed unit 112b performs the role of a secondary or backup distributed unit to the first distributed unit 112a. It will be understood that the act of activating the second distributed unit 112b and enabling communications to the centralized unit 118 can be performed in a small period of time based on the second SCTP connection being previously established at act 204.

As noted above, activating the second SCTP connection may involve initiating an active or operational state of the second distributed unit 112b in a manner which simply enables the second distributed unit 112b to use the previously established SCTP connection. In one or more embodiments, the middlebox resiliency system 116 additionally provides one or more parameters (e.g., configuration parameters) to the second distributed unit to reconfigure one or more parameters as needed to match the first distributed unit 112a and avoid potential service interruptions. These parameters may include instructions that, when executed by the second distributed unit 112b, cause the second distributed unit 112b to operate in accordance with a similar or identical set of parameters as the first distributed unit 112a prior to experiencing the failure condition. As an illustrative example, where the first distributed unit (prior to the failure condition) operates at a 3.5 GHz frequency while the second distributed unit 112b is configured to operate at a 3.4 GHz frequency, the second distributed unit may be re-configured as part of the act of activating the second SCTP connection and causing the second distributed unit 112b to engage an active or operational mode that matches or otherwise corresponds to the active or operational mode of the first distributed unit 112a.

As shown in FIG. 2, once the second SCTP connection is activated and the second distributed unit 112b has engaged an operational mode, the second distributed unit 112b and the centralized unit 118 may perform an act 218 of communicating packets between the respective units. The act 218 of communicating packets may be performed in a similar manner as discussed above in connection with the act 206 of communicating packets between the first distributed unit 112a and the centralized unit 118.

Upon resuming communication between the second distributed unit 112b and the centralized unit 118, the middlebox resiliency system 116 may perform an act 220 of monitoring failure conditions associated with the second distributed unit 112b. The act 220 of monitoring failure conditions may include similar features as the act 208 of monitoring failure conditions associated with the first distributed unit 112a.

While not shown in FIG. 2, in the event that the first distributed unit 112a goes down, the middlebox resiliency system 116 may identify or designate another distributed unit to act as a secondary or backup unit to the second distributed unit 112b upon activation of the second distributed unit 112b. In this manner, the middlebox resiliency system 116 may maintain redundancy of another distributed unit within the telecommunications network in the event that the second distributed unit 112b experiences a failure condition. In some embodiments, the middlebox resiliency system 116 may maintain more than one secondary distributed unit to ensure that at least one distributed unit is available for vRAN recovery, such as in the event where the failure condition is more widespread and affects server devices on which both the first distributed unit 112a and the second distributed unit 112b are implanted.

In addition, it will be noted that once established as the primary distributed unit, the second distributed unit 112b may act as the primary distributed unit for any duration of time as may fit a particular embodiment. For example, in one or more embodiments, the second distributed unit 112b acts as the primary distributed unit indefinitely without any plan to switch back to the first distributed unit 112a. Alternatively, in one or more embodiments, the second distributed unit 112b may act as the primary distributed unit until the first distributed unit 112a is back online and ready to re-engage with the centralized unit 118 via the first SCTP connection or a re-established or newly established SCTP connection.

In one or more embodiments, an additional distributed unit (other than the first or second distributed units 112a-b) is named or re-purposed as a backup distributed unit to the second distributed unit 112b based on the first distributed unit 112a going down and being no longer available to perform the role of the primary or backup distributed unit. In this example, a connection (e.g., an SCTP connection) may be established by the middlebox resiliency system 116 between the additional distributed unit and the centralized unit 118. In addition, the middlebox resiliency system 116 may monitor performance of the second distributed unit 112b (e.g., the primary distributed unit in this example) to determine whether the SCTP connection with the additional distributed unit needs to be activated responsive to a detected failure condition of the second distributed unit 112b.

In addition, while one or more examples illustrated and discussed herein refer specifically to implementations in which a single primary distributed unit has a single backup distributed unit, other implementations may include a different ratio of primary and secondary distributed units. For example, one or more embodiments may include multiple backup distributed units that service or otherwise act as backups to multiple primary distributed units. Alternatively, because unexpected failures in distributed units are not a frequent or common occurrence in many networks, a single secondary or backup distributed unit may act as a backup distributed unit to a plurality of primary distributed units that have active and operational connection (e.g., SCTP connections) with the centralized unit. In this example, the SCTP connection between the backup distributed unit and the centralized unit may be activated in a manner that enables the backup distributed unit to recover from a distributed unit failure of one of a plurality of primary distributed units.

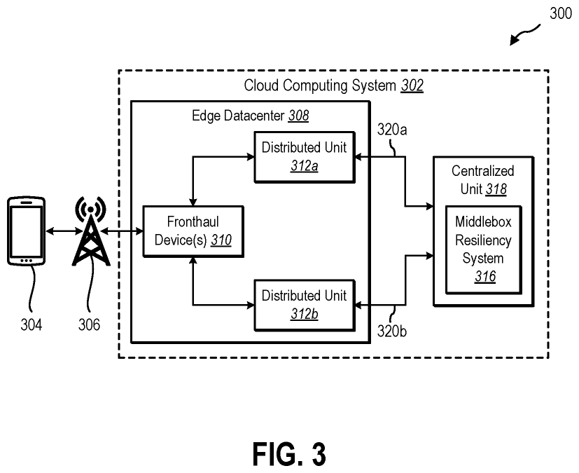

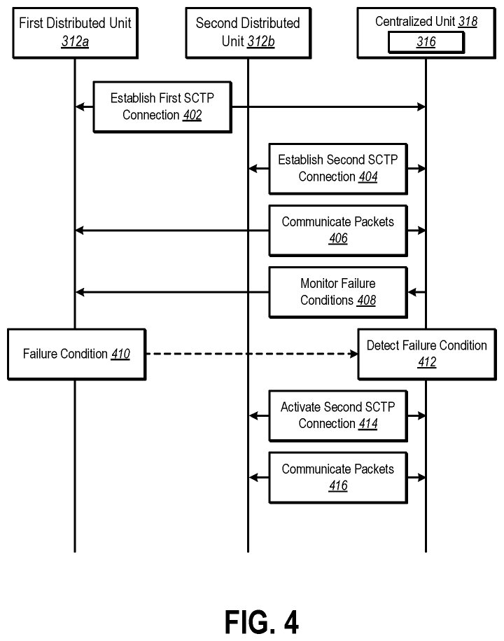

Additional detail will now be discussed in connection with an example implementation of the middlebox resiliency system 116 in accordance with one or more embodiments described herein. In particular, FIGS. 3-4 illustrate an example implementation of a telecommunications network in which the middlebox resiliency system 116 is implemented on a centralized unit of a vRAN on a cloud computing system. It will be appreciated that features described in connection with FIGS. 3-4 may be applicable to one or more embodiments described above in connection with FIGS. 1-2. Moreover, one or more features and functionalities described above in connection with FIGS. 1-2 may be applicable to the example(s) shown and discussed in connection with FIGS. 3-4.

Similar to FIG. 1, FIG. 3 illustrates an example environment 300 in which a middlebox resiliency system 316 is implemented in accordance with one or more embodiments. As shown in FIG. 1, the environment may include a user equipment 304 (or simply “UE 304”) and a radio unit 306 that provides access to components on a cloud computing system 302 to the UE 304. Similar to FIG. 1, the components shown within the cloud computing system 302 may include components of a vRAN.

As shown in FIG. 3, the environment further includes an edge datacenter 308 having one or more front haul device(s) 310 and a plurality of distributed units 312a-b. The distributed units 312a-b may include a first distributed unit 312a (e.g., a primary distributed unit) and a second distributed unit 312b (e.g., a backup or secondary distributed unit). It will be understood that each of the UE 304, radio unit 306, edge datacenter 308, fronthaul device(s) 310, and distributed units 312a-b may include similar features as corresponding components discussed above in connection with FIG. 1.

In contrast to FIG. 1, the environment 300 includes a centralized unit 318 having the middlebox resiliency system 316 implemented thereon. Thus, rather than the middlebox resiliency system 316 acting as a middlebox entity positioned between the distributed units 312a-b and the centralized unit 318, the middlebox resiliency system 316 may be implemented as a software package or set of features that are implemented directly on the centralized unit 318 (or on a server device on which the centralized unit 318 is hosted).

As shown in FIG. 3, the middlebox resiliency system 316 may establish a first connection 320a between the first distributed unit 312a and the centralized unit 318. The middlebox resiliency system 316 may also establish a second connection 320b between the second distributed unit 312b and the centralized unit 318. Similar to one or more embodiments described above, the first connection 320a may be a first SCTP connection and the second connection 320b may be a second SCTP connection. The connections 320a-b may share similar features as the corresponding connections discussed above.

Each of the above examples of the middlebox resiliency system implemented on a separate device (e.g., as shown in FIG. 1) or within the centralized unit provide a variety of benefits. For example, where the middlebox resiliency system is implemented as a standalone entity on a server device positioned between the distributed units and the centralized unit, the middlebox resiliency system facilitates the features that enhance vRAN resiliency without modifying the existing framework of the vRAN. Indeed, the standalone middlebox resiliency system provides a framework that enables detection and recovery from distributed unit failures without requiring that the centralized unit modify a configuration implemented thereon. Indeed, in one or more embodiments, the centralized unit may be unaware of involvement of the middlebox resiliency system other than establishing the SCTP connection between the centralized unit and the respective distributed units.

Alternatively, in the example shown in FIG. 3 in which the middlebox resiliency system is implemented within the centralized unit 318, the above-features the enhance resiliency of the vRAN may be implemented as part of the existing functionality of the centralized unit. Integrating the functionality of the middlebox resiliency system within the centralized unit provides a flexible and adaptive approach to increasing resiliency in a manner that is scalable, flexible, and dynamically configurable to adapt to changing services and additional distributed units that are added to the set of distributed units that the centralized unit is tasked with managing.

Moving on, FIG. 4 illustrates an example implementation in accordance with the example shown in FIG. 3 in which a middlebox resiliency system 316 on a centralized unit 318 may be used to improve resilience within a vRAN including the first distributed unit 312a and the second distributed unit 312b. Each of the distributed units 312a-b, middlebox resiliency system 316, and centralized unit 318 may have similar features as discussed in previous examples.

As shown in FIG. 4, the centralized unit 318 and the first distributed unit 312a may perform an act 402 of establishing a first SCTP connection. As further shown, the centralized unit 318 and the second distributed unit 312b may perform an act 404 of establishing a second SCTP connection. As further shown, the centralized unit 318 and the first distributed unit 312a (e.g., the primary distributed unit) may perform an act 406 of communicating packets between the respective devices. It will be appreciated that, while performed by different devices, the acts 402-406 may be performed in a similar fashion as corresponding acts 202-206 discussed above in connection with FIG. 2.

As shown in FIG. 4, the centralized unit 318 may perform an act 408 of monitoring failure conditions on the first distributed unit 312a. Monitoring conditions of the first distributed unit 312a may involve an agent on the distributed unit 312a providing frequent health signals. In one or more embodiments, the centralized unit 318 may receive an indication of non-responsiveness (or other failure indicator) from an Ethernet switch or other front haul device(s) 310.

As shown in FIG. 4, the first distributed unit 312a performs an act 410 of experiencing a failure condition. The centralized unit 318 may perform the act 412 of detecting the failure condition. In response to detecting the failure condition, the centralized unit 318 and second distributed unit 312b may perform an act 414 of activating the second SCTP connection with the second distributed unit 312b. The centralized unit 318 and second distributed unit 312b may perform an act 416 of communicating packets. While not shown in FIG. 4, the centralized unit 318 may continue monitoring failure conditions of the second distributed unit 312b to determine if another distributed unit (e.g., having a pre-established SCTP connection with the centralized unit 318) needs to be activated.

It will be noted that each of the above-illustrated examples show distributed units implemented on a single edge network. Notwithstanding these examples, in one or more embodiments, the distributed units may be implemented on different datacenters. For example, in one or more embodiments, the first distributed unit is implemented on a first edge network that is serviced or otherwise managed by the centralized unit while the second distributed unit is implemented on a second edge network that is also serviced or otherwise managed by the centralized unit.

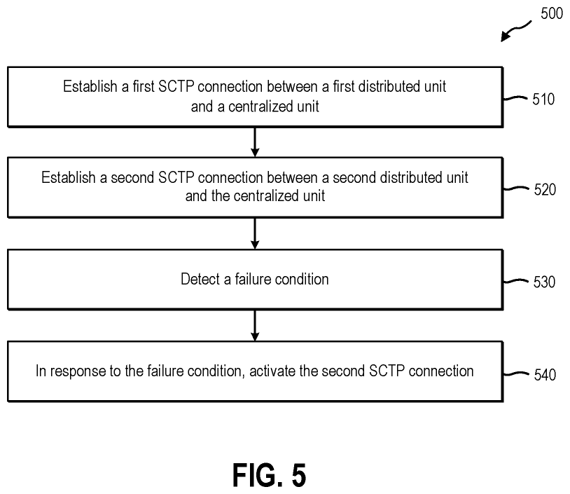

Turning now to FIG. 5, this figure illustrates an example flowchart including a series of acts for increasing resiliency in a vRAN including a number of distributed units and a centralized unit. While FIG. 5 illustrates acts according to one or more embodiments, alternative embodiments may omit, add to reorder, and/or modify any of the acts shown in FIG. 5. The acts of FIG. 5 may be performed as part of a method. Alternatively, a non-transitory computer-readable medium can include instructions thereon that, when executed by one or more processors, cause a server device and/or client device to perform the acts of FIG. 5. In still further embodiments, a system can perform the acts of FIG. 5.

FIG. 5 illustrates a series of acts 500 in which a middlebox resiliency system as discussed in connection with one or more embodiments described herein increases vRAN resiliency in a telecommunications environment (e.g., a 5G mobile communications network). As shown in FIG. 5, the series of acts 500 includes an act 510 of establishing a first SCTP connection between a first distributed unit and a centralized unit. In one or more embodiments, the act 510 includes establishing, by a middlebox entity, a first stream control transmission protocol (SCTP) connection between the centralized unit and a first distributed unit of the plurality of distributed units.

As further shown in FIG. 5, the series of acts 500 includes an act 520 of establishing a second SCTP connection between a second distributed unit and the centralized unit. In one or more embodiments, the act 520 includes establishing, by the middlebox entity, a second SCTP connection between the centralized unit and a second distributed unit of the plurality of distributed units.

As further shown in FIG. 5, the series of acts 500 includes an act 530 of detecting a failure condition. In one or more embodiments, the act 530 includes detecting a failure condition of the first distributed unit. The act may be detected by the middlebox entity.

As further shown in FIG. 5, the series of acts 500 includes an act 540 of, in response to the failure condition, activating the second SCTP connection. In one or more embodiments, the act 540 includes, in response to detecting the failure condition of the first distributed unit, activating the second SCTP connection and causing fronthaul traffic to be routed to the second distributed unit.

In one or more embodiments, establishing the first SCTP connection and establishing the second SCTP connection is performed using a middlebox entity on a server device positioned between the first distributed unit and the centralized unit and between the second distributed unit and the centralized unit. In one or more embodiments, establishing the first SCTP connection and establishing the second SCTP connection is performed using a middlebox entity implemented on the centralized unit.

In one or more embodiments, the first distributed unit is implemented on a first server device of an edge network while the second distributed unit is implemented on a second server device of the edge network. In one or more embodiments, the first distributed unit is implemented on a first server device of a first edge network in communication with a radio unit while the second distributed unit is implemented on a second server device of a second edge network in communication with the radio unit. Each of the first edge network and the second edge network may be serviced by the centralized unit.

In one or more embodiments, detecting the failure condition includes causing an agent of the first distributed unit to periodically communicate a status message to the middlebox entity. In one or more embodiments, detecting the failure condition includes causing an Ethernet switch positioned between the first distributed unit and a radio unit to communicate to the middlebox entity that a threshold period of time has passed without detecting a communication between the Ethernet switch and the first distributed unit.

In one or more embodiments, the series of acts 500 includes configuring the second distributed unit to run on a low power mode prior to detecting the failure condition. In response to detecting the failure condition of the first distributed unit, the series of acts 500 may include causing the second distributed unit to run in an operational mode.

In one or more embodiments, the middlebox entity is a network function implemented in the virtualized radio access network of a 5G telecommunications network. In one or more embodiments, the series of acts 500 includes, in response to detecting the failure condition, sending shutdown signal to the centralized unit to clear a state of the first distributed unit.

FIG. 6 illustrates certain components that may be included within a computer system 600. One or more computer systems 600 may be used to implement the various devices, components, and systems described herein.

The computer system 600 includes a processor 601. The processor 601 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. In a telecommunications environment including a plurality of distributed units and a centralized unit on a virtualized radio access network, a method for increasing resilience in the virtualized radio access network, the method comprising:
establishing, by a middlebox entity, a first stream control transmission protocol (SCTP) connection between the centralized unit and a first distributed unit of the plurality of distributed units;
establishing, by the middlebox entity, a second SCTP connection between the centralized unit and a second distributed unit of the plurality of distributed units;
detecting a failure condition of the first distributed unit; and
in response to detecting the failure condition of the first distributed unit, activating the second SCTP connection and causing fronthaul traffic to be routed to the second distributed unit.

2. The method of claim 1, wherein establishing the first SCTP connection and establishing the second SCTP connection is performed using a middlebox entity on a server device positioned between the first distributed unit and the centralized unit and between the second distributed unit and the centralized unit.

3. The method of claim 1, wherein establishing the first SCTP connection and establishing the second SCTP connection is performed using a middlebox entity implemented on the centralized unit.

4. The method of claim 1,
wherein the first distributed unit is implemented on a first server device of an edge network, and
wherein the second distributed unit is implemented on a second server device of the edge network.

5. The method of claim 1,
wherein the first distributed unit is implemented on a first server device of a first edge network in communication with a radio unit, and
wherein the second distributed unit is implemented on a second server device of a second edge network in communication with the radio unit.

6. The method of claim 5, wherein each of the first edge network and the second edge network is serviced by the centralized unit.

7. The method of claim 1, wherein detecting the failure condition includes causing an agent of the first distributed unit to periodically communicate a status message to the middlebox entity.

8. The method of claim 1, wherein detecting the failure condition includes causing an Ethernet switch positioned between the first distributed unit and a radio unit to communicate to the middlebox entity that a threshold period of time has passed without detecting a communication between the Ethernet switch and the first distributed unit.

9. The method of claim 1, further comprising:
configuring the second distributed unit to run on a low power mode prior to detecting the failure condition; and
in response to detecting the failure condition of the first distributed unit, causing the second distributed unit to run in an operational mode.

10. The method of claim 1, wherein activating the second SCTP connection includes providing one or more configuration parameters to the second distributed unit including instructions executable by the second distributed unit to engage in an operational mode that corresponds to the first distributed unit prior to the failure condition.

11. The method of claim 1, wherein the middlebox entity is a network function implemented in the virtualized radio access network of a 5G telecommunications network.

12. The method of claim 1, further comprising, in response to detecting the failure condition, sending shutdown signal to the centralized unit to clear a state of the first distributed unit.

13. In a 5G telecommunications network including a plurality of distributed units and a centralized unit on a virtualized radio access network, a method performed by a centralized unit for increasing resilience in the virtualized radio access network, the method comprising:
causing a first stream control transmission protocol (SCTP) connection to be established between the centralized unit and a first distributed unit of the plurality of distributed units;
causing a second SCTP connection to be established between the centralized unit and a second distributed unit of a plurality of distributed units;
detecting a failure condition of the first distributed unit; and
in response to detecting the failure condition of the first distributed unit, activating the second SCTP connection and causing fronthaul traffic to be routed to the second distributed unit.

14. The method of claim 13,
wherein the first distributed unit is implemented on a first server device of an edge network, and
wherein the second distributed unit is implemented on a second server device of the edge network.

15. The method of claim 13,
wherein the first distributed unit is implemented on a first server device of a first edge network in communication with a radio unit, and
wherein the second distributed unit is implemented on a second server device of a second edge network in communication with the radio unit.

16. The method of claim 15, wherein detecting the failure condition includes one or more of:
causing an agent of the first distributed unit to periodically communicate a status message to the centralized unit; or
causing an Ethernet switch positioned between the first distributed unit and a radio unit to communicate to the centralized unit that a threshold period of time has passed without detecting a communication between the Ethernet switch and the first distributed unit.

17. The method of claim 15, further comprising:
configuring the second distributed unit to run on a low power mode prior to detecting the failure condition; and
in response to detecting the failure condition of the first distributed unit, causing the second distributed unit to run in an operational mode.

18. The method of claim 13, further comprising, in response to detecting the failure condition, sending shutdown signal to the centralized unit to clear a state of the first distributed unit

19. A system, comprising:
at least one processor;
memory in electronic communication with the at least one processor; and
instructions stored in the memory, the instructions being executable by the at least one processor to:
establish, by a middlebox entity, a first stream control transmission protocol (SCTP) connection between a centralized unit and a first distributed unit;
establish, by the middlebox entity, a second SCTP connection between the centralized unit and a second distributed unit;
detect a failure condition of the first distributed unit; and
in response to detecting the failure condition of the first distributed unit, activate the second SCTP connection and causing fronthaul traffic to be routed to the second distributed unit.

20. The system of claim 19, wherein establishing the first SCTP connection and establishing the second SCTP connection is performed:
using a middlebox entity on a server device positioned between the first distributed unit and the centralized unit and between the second distributed unit and the centralized unit; or
using a middlebox entity implemented on the centralized unit.
